(19) United States
(12) Patent Application Publication
(10) Pub. No.: US 2004/0201697 A1
(43) Pub. Date: Oct. 14, 2004

(54) "Black-box" video or still recorder for commercial and consumer vehicles

(76) Inventor: Vernon Lawrence Klein, Pleasanton, CA (US)

Correspondence Address: Pixim, Inc., 7394 Wildflower Way, Cupertino, CA, 95014, US

(21) Appl. No.: 09/850,605

(22) Filed: May 7, 2001

(51) Int. Cl. H04N 5/225

(52) U.S. Cl. 348/207.99

(57) ABSTRACT

A method and system for monitoring an automobile is disclosed. A centralized black box receives and stores images from different image sensors positioned on the vehicle. In one example, digital pixel sensors are used to provide image data. One of the features in the digital pixel sensors is the multi-capturing image capability that ensures that the image data is non-saturated. As a result, details can be captured in the image data regardless an automobile drives constantly from a bright condition to a dark condition or vice versa.

### CROSS-REFERENCE TO RELATED APPLICATION

This application is related to U.S. app. Ser. Nos. 09/567,786 and 09/567,638, both filed May 9, 2000, each of which is hereby incorporated by reference.

### BACKGROUND OF THE INVENTION

1. Technical Field

The invention relates to image sensor systems. More particularly, the invention relates to the application of an image sensor architecture and associated method to an automobile monitoring system.

2. Description of the Prior Art

Traffic accidents are a frequent occurrence. For legal and insurance reasons, a motorist must determine the cause of the accident. Many times, however, the motorist is confronted by conflicting testimony, or no testimony at all, regarding the accident. A method and system for recording the environment of the car as well as the events leading up to the accident would be of great assistance in puzzling out the causes of an automobile accident after the fact.

Filming the car's environment while the car is in motion using standard videotape machinery is not an attractive option, as the videotapes storing the information would require a lot of room for storage. While digital cameras would allow for some decrease in the storage area required, the digital cameras available nowadays offer less in the areas of dynamic range and processing time. Both of these areas would be crucial for such a device to provide the information needed, as the dynamic range can change quickly and crucial information about an accident can occur in less than a second.

What are needed are a system and method for monitoring the surrounding environment of an automobile that can the store the data efficiently and react quickly to changing environmental conditions.

### SUMMARY OF THE INVENTION

In one embodiment of the present invention, a method and system for monitoring an automobile are disclosed. A centralized black box receives and stores information, including images, from different sensors positioned on the vehicle. These sensors may include, but not be limited to, speed sensors and temperature sensors monitor different conditions of the automobile, such as speed and engine temperature. According to the present invention, some of these sensors also include digital image sensors for increased contrast dynamic range and that have analog to digital conversion circuits at a pixel level to facilitate multisampling image capturing.

### BRIEF DESCRIPTION OF THE DRAWINGS

FIG. 1 is a block diagram that shows the invention implemented upon a truck;

FIG. 2 is a flowchart that shows the method used to store the information gathered into memory; and

FIG. 3 shows an example of a multisampling of an image or multiple exposures of a scene.

### DETAILED DESCRIPTION OF THE INVENTION

In the following detailed description of the invention, some specific details are set forth to provide a thorough understanding of the presently preferred embodiment of the invention. However, it should be apparent to those skilled in the art that the invention may be practiced in embodiments that do not use the specific details set forth herein. Well known methods, procedures, components, and circuitry have not been described in detail to avoid unnecessarily obscuring the invention.

The present invention uses advances in digital sensory equipment and memory storage methods and applies them to developing a system and method for monitoring land vehicles. The device is not limited to automobiles and could in fact be applied to any land vehicle, such as motorcycles, tractors, and construction equipment. In particular, the new system attaches digital image sensors in strategic locations on a land vehicle. These sensors monitor respectively the environment surrounding the vehicle and store generated data into a centralized storage unit. In this data storage unit, all data that is within a previously specified time frame is stored until the happening of an event, such as a collision with another vehicle. The further intake of data is frozen until the data presently stored is reviewed. In one embodiment, security measures are placed to prevent tampering with the data.

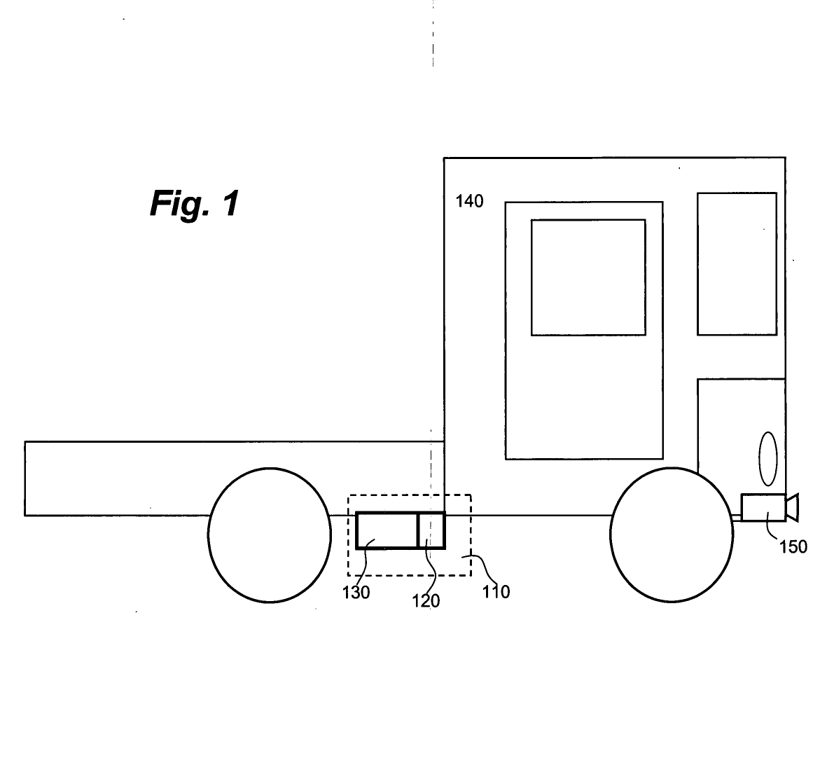

FIG. 1 displays one exemplary embodiment for this invention. A centralized “black box” 110 containing electronic signal processing circuitry 120 and electronic storage medium 130 is mounted on a vehicle 140. The black box system is activated when the vehicle is started and continues to run until the vehicle is turned off. During operation, the black box takes in and stores electronic information from various electronic “sensory inputs” or sensors 150. The sensors can be attached to the automobile in a variety of places beyond the one shown in FIG. 1.

In one exemplary embodiment, these sensors can include information about the speed the vehicle is traveling, or measurements of the state of the engine such as fluid levels or temperature. Many of these sensors are readily available in the current technology. Additionally, recent advances in digital pixel sensor (DPS) technology increase the viability of including video/still images taken outside/inside the vehicle by various mounted cameras.

In one embodiment, the electronic storage medium used in the black box would be non-volatile solid-state storage, such as flash memory. Other possible storage mediums include tape-based mediums such as DV, or disc based storage devices such as MiniDisc, CD or DVD. To save on cost, the storage medium would most likely utilize a fixed memory size, first in first out data storage architecture. The controlling circuit for the black box would direct the data storage medium to record information until the storage capacity of the medium is completely filled.

Any new information obtained at this point would be recorded over the least recent information. This method allows for the most recent events to always be present in the system memory. The storage capacity could be adjusted to suit the need of the application. For example, a memory buffer could be kept to maintain up to ten minutes of memory. The buffer maintains data to reflect the scene ten minutes before an accident happens.

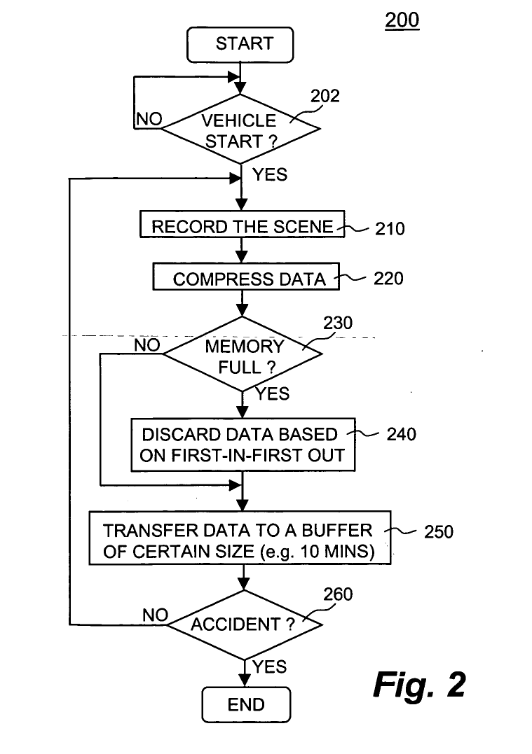

In one embodiment, the “black box” system collects the information following a method illustrated by flowchart 200 in FIG. 2. The flowchart is presented according to one embodiment of the present invention. The order therein shall not be construed as limitations to the present invention. Different embodiments may result in different orders of the process in flowchart 200. Once the vehicle has started 202, the sensors begin to record the scene surrounding the vehicle 210. The data in this recording is compressed 220. Before the data is transferred to a buffer of a certain size, the process first checks if the buffer can accommodate more data 230. If it is determined that the buffer is full, the data therein is discarded on a first-in-first-out basis 240. In one embodiment, a fixed amount of data is discarded. In another embodiment, an amount of data is discarded to just leave a sufficient space to accommodate new data from 220. In any case, the compressed data from 220 is transferred to the buffer 250. If no accident occurs 260, the process goes back to 210 to continue monitoring the surroundings of the vehicle. If an accident does occur 260, the recording process immediately stops 270 or stops after a predetermined time (e.g. 2 seconds) provided that the sensing equipment still operates.

Video images or digital still photos of the surrounding embodiment could be stored into the data storage unit.

Camera modules deployed on the vehicle could use various solid-state circuit technologies to collect, process and transmit the image information back to the base unit. To collect image information, digital pixel sensors (DPS) technology is deployed to accommodate various lighting conditions the vehicle may enter. Generally, a vehicle may drive under very bright or dark conditions. Traditional CCD or CMOS image sensors would produce saturated images under such dynamically changed lighting conditions. One of the features in the DPS technology is the ability to prevent the digital pixel sensors from producing saturated images. With its pixel-level analog-to-digital convention circuitry, a multisampling process during an image capture is made possible.

As disclosed in U.S. App. Nos.: 09/567,786 and 09/567,638, one of the features in a digital pixel sensor is the high dynamic range achievable via multisampling. A large dynamic range greatly increases the useful information in images captured by the camera using the digital pixel sensor. A low-cost, commercially available digital pixel sensor can have a dynamic range of greater than 100 dB with 16-bit quantization, or 131 dB with 20-bit quantization.

The DPS for the automobile “black box” may be implemented according to U.S. app. Ser. Nos. 09/567,786 and 09/567,638. The DPS differs from standard digital picture technology in that each pixel sensor is comprised of not only the photosensitive element, but also element-level analog-to-digital conversion circuits. The element-level analog-to-digital conversion circuits alleviate the main cause of long data readout time on standard digital cameras, the bottleneck created between the photosensitive elements and subsequent data memory. With the improved readout time in the DPS, multiple image data can be readout to the data memory during an image capture. To prevent image data saturation, innovative measures are taken to ensure that only will non-saturated data be read into the memory.

In one embodiment, the DPS for the automobile “black box” comprises a photosensitive chip. The photosensitive chip, which is typically fabricated on a substrate such as CMOS, comprises a plurality of photodetectors that are arranged in a 2-dimensional array. The number of the photodetectors in the photosensitive chip typically determines the resolution of the resulting digital images, with horizontal resolution related to photodetectors per row, and vertical resolution related to photodetectors per column.

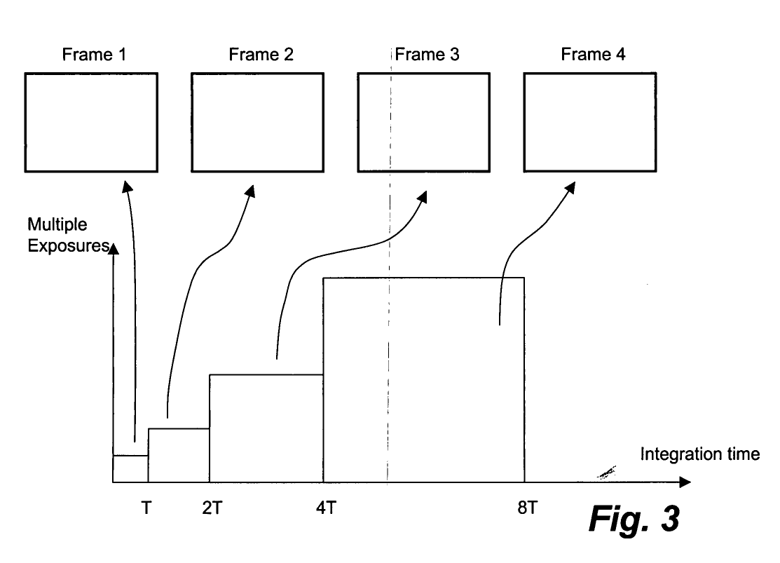

The dynamic range problems occur in most digital cameras because one of the photosensitive elements may become saturated with photons while another might not receive enough photons to even leave an image. This contrast is especially important in capturing images from a moving automobile, which might be going constantly from dark to light or vice versa. FIG. 3 shows an example of the multi-sampling image capturing. It is assumed that an image sensor in a camera mounted on a vehicle is set to expose to a scene for a duration of S (e.g. 1/60 second) and 4 samples are to be read. Each of the samples is read out at T, 2T, 4T and 8T, wherein 8T=S or T=S/T. As shown in FIG. 3, frame 1 is created after time T, frame 2 is created after time 2T accumulating from T, frame 3 is created after time 4T accumulating from T and 2T, and frame 4 is created after time 8T accumulating from T, 2T and 4T. One of the advantages of having multiple images of the same target within an exposure time is the ability to expand the dynamic range of the image captured as pixel values in each of the frames can be selectively read into the data memory in accordance with a threshold value. Because of the relative short exposure time, frame 1 typically captures information that is related to high illumination areas in the target. Likewise, because of the relatively long exposure time, frame 4 typically captures information that is related to low illumination areas in the target. Frame 2 and frame 3 thus capture information that is related to gradually increased illumination areas in the target. As a result, the combination of the multiple images provides a very wide dynamic range.

The above multisampling imaging, i.e. multiple images of the same target within an exposure may be appreciated from another perspective. When the target has an extremely high contrast, namely, the bright area is very bright and the dark area is very dark, a single exposure setting could hardly generate an image including details both in the bright and dark areas. A more ideal solution would be to create a single image from two exposure settings, one for the bright area and one for the dark area, which is practically difficult to achieve with the current technology. With the present invention, the two or more exposure settings are “simulated” by accumulating exposure time of the same target and generating multiple images thereof. A composition of the multiple images with respect to existing values of each pixel leads to a final image including details both in the bright and dark areas.

In operation, when a value in the threshold memory cell detects that a corresponding photodetector is saturated, the accumulated charge from the corresponding photodetector in subsequent frames will be prevented from being written into the corresponding data memory cell. This feature is very important to the imaging for the automobile “blackbox” and is believed a significant departure from a conventional image sensor.

At the end of an exposure, image data in the data memory is transmitted to a memory device in the “black box”. To improve image quality or reduce the amount of image data being sent back to the memory device, image processing and compression may be done in the camera modules. To transmit the data back to the black box, various techniques may be deployed such as direct wire connection, or utilization of a wireless protocol such as Bluetooth.

The advantages of the invention are numerous. Different embodiments or implementations as a method, a system and an apparatus may yield at least one or more of the following advantages. One advantage of the invention is that the present invention now makes it feasible for an automobile to be equipped with imaging sensors that record surrounding conditions of the automobile prior to an accident. Another advantage of the invention is the employment of one or more digital pixel sensors that can produce non-saturated image data regardless of the lighting conditions in which a vehicle operates. Many other features and advantages of the present invention are apparent from the written description, and thus, it is intended by the appended claims to cover all such features and advantages of the invention. Further, since numerous modifications and changes will readily occur to those skilled in the art, it is not desired to limit the invention to the exact construction and operation as illustrated and described. Hence, all suitable modifications and equivalents may be considered to fall within the scope of the invention.

1. A monitoring system for a ground transportation vehicle, the system comprising:
an imaging device employing a digital pixel sensor for monitoring an environment of the vehicle, the digital pixel sensor producing multiple images within a predetermined exposure time, the images read out respectively at a set of time periods within the exposure time to produce digital image data, wherein a longest time period of the set of time periods does not exceed the exposure time;
a controlling circuit for initiating and terminating a measurement activity for the imaging device; and
an electronic storage medium for storing a succession of the digital image data from the digital pixel sensor.

2. The monitoring system of claim 1, wherein the digital pixel sensor comprises an array of photosensitive elements, each of the photosensitive elements coupled to an analog to digital conversion circuit.

3. The monitoring system of claim 2, wherein each of the photosensitive elements couples to a memory cell so that data generated by the each of the photosensitive elements can be directly written into the memory cell.

4. The monitoring system of claim 1, wherein the digital pixel sensor includes data memory that is coupled to the electronic storage medium.

5. The monitoring system of claim 4, wherein the electronic storage medium is configured to store image data for a predefined period, and wherein the electronic storage medium is configured to dump least recent image data when receiving latest image data.

6. The monitoring system of claim 5, wherein the electronic storage medium is configured to stop receiving image data after a certain time if the monitoring system still operates.

7. The monitoring system of claim 1, wherein the controlling circuit initiates a measurement by the imaging device at a regularly spaced interval.

8. The monitoring system of claim 1, wherein the controlling circuit terminates measurements by the imaging device in the event of damage to the ground transportation vehicle.

9. The monitoring system of claim 1, wherein the controlling circuit terminates recording by the electronic storage medium in the event of damage to the ground transportation vehicle.

10. The monitoring system of claim 1, wherein the electronic storage medium utilizes a first in first out data storage architecture.

11. The monitoring system of claim 10, wherein the electronic storage medium is one of a non-volatile solid-state storage device, a tape based medium, and disc based storage device.

12. The monitoring system of claim 1, wherein the electronic storage medium has a security device implanted to prevent tampering image data therein

13. A ground transportation vehicle monitoring method, the method comprising:
collecting image information about surrounding driving conditions of the vehicle, wherein the image information is produced in an imaging device employing a sensor capable of generating multiple images within a predetermined exposure time, the images read out respectively at a set of time periods within the exposure time to produce the image information, and wherein, a longest time period of the set of time periods does not exceed the exposure time;
transmitting said image information to a base unit on the vehicle; and
storing said information in an electronic storage medium.

14. The method of claim 13, wherein the vehicle is equipped with a plurality of such imaging device, each placed on a designated part of the vehicle.

15. The method of claim 14, wherein the image information is compressed in accordance with a compression scheme.

16. The method of claim 13, wherein the electronic storage medium is configured to have a capacity for a predetermined period.

17. The method of claim 16, wherein the storing of the image information comprising discarding least recent stored image information when receiving the image information from the imaging device.

18. The method of claim 17, wherein the storing of the image information is immediately stopped in the event of damage to the ground transportation vehicle.
